(19) United States
(12) Patent Application Publication
(10) Pub. No.: US 2006/0185948 A1
(43) Pub. Date: Aug. 24, 2006

(54) Damping valve

(75) Inventor: Stefan Schmitt, Harthausen (DE)

Correspondence Address: COHEN, PONTANI, LIEBERMAN & PAVANE, 551 FIFTH AVENUE, SUITE 1210, NEW YORK, NY, 10176, US

(73) Assignee: ZF Friedrichshafen AG, Friedrichshafen (DE)

(21) Appl. No.: 11/359,707

(22) Filed: Feb. 22, 2006

(30) Foreign Application Priority Data
Feb. 23, 2005 (DE) 10 2005 008 162.2

(51) Int. Cl. F16F 9/348

(52) U.S. Cl. 188/282.5

(57) ABSTRACT

Damping valve device having a damping valve body with at least one flow channel, which is closed at least partially by a first spring-loaded valve disk on a first valve seating surface, and a second spring-loaded valve disk, which rises from its valve seat at a higher opening pressure than the first valve disk. One of the cover sides of the first spring-loaded valve disk is held under tension on the first valve seating surface while the other cover side is held under tension on a second valve seating surface, and one of the valve seating surfaces of the first valve disk executes a lifting movement synchronously with the second spring-loaded valve disk.

### BACKGROUND OF THE INVENTION

1. Field of the Invention

The invention pertains to a damping valve having a valve body with a flow channel which is closed by a first spring loaded valve disk and a second spring loaded valve disk which rises from its seat at a higher opening pressure than the first disk.

2. Description of the Related Art

Damping valves for vibration dampers often have a so-called “pilot” cross section, which is formed by, for example, a small aperture in a valve disk. Small volume flow rates, which occur during the movement of the piston rod, flow completely through the pilot cross section and generate a comparatively small damping force. As soon as the velocity of the piston rod exceeds a certain value, however, a valve disk rises from a valve seat and releases a cross section which is much larger than the pilot cross section. The closing forces acting on the valve disk, which are introduced by at least one spring, are carefully coordinated to ensure that the damping valve shows the desired damping force behavior, preferably a degressive behavior.

As is known from DE 44 24 434 A1, multi-stage damping valves offer increased driving comfort. In the case of a multi-stage damping valve which, in addition to the pilot cross section, also has two valve disks, which are also spring-loaded, it is possible to achieve stronger damping forces at smaller-to-moderate piston rod velocities while still obtaining degressive damping force curves at higher piston rod velocities. FIG. 3 of DE 44 24 434 shows this relationship in the form of a characteristic damping force diagram.

In DE 44 24 434 A1, the additional valve is formed by a small valve disk, which pretensions a disk spring in the closing direction. The disk spring can be supported as desired against either a stationary surface or a valve disk.

U.S. Pat. No. 6,371,264 also describes a damping valve with multi-stage opening behavior, the pilot valve of which is on the top surface of the damping valve body. The outer edge of a valve disk can rise from its valve seating surface until it reaches a stop disk. If the force of the opening pressure acting on this valve disk increases even more, the entire valve disk is moved in the opening direction together with the stop disk against the force of an additional valve spring.

In both of the documents cited above, the problem is that the valve seating surfaces for the additional valve must be manufactured with extreme precision so that even the smallest leak is avoided. If one were simply to increase the force of the spring acting on the valve disk, a better sealing function might be obtained under certain conditions, but the characteristic force curve would become worse with respect to driving comfort.

### SUMMARY OF THE INVENTION

The object of the present invention is to realize a multi-stage damping valve which makes it possible to produce many different variants of the damping force characteristic and which at the same time can be easily manufactured.

According to the invention, one of the cover sides of the first spring-loaded valve disk is held under tension against the first valve seating surface, while the other cover side is held under tension against a second valve seating surface, where one of the valve seating surfaces of the first valve disk executes a lifting movement in synchrony with the second spring-loaded valve disk.

The great advantage here is that the first valve disk rests on the valve seating surfaces with a very effective sealing action. No leaks occur which would otherwise have to be corrected by means of an additional seal to obtain the most precise possible damping force characteristic.

In another advantageous embodiment, a valve seating surface for the first valve disk is produced directly on the second valve disk. The design of the overall valve device is thus simplified. In addition, the force required to open the second valve disk can be determined by adjusting the pretensioning force of the first valve disk, which means overall that the damping force characteristic of the damping valve device can be varied in many different ways.

In another advantageous embodiment, the second valve disk provides a discharge channel for the first valve disk. The damping medium flowing from the flow channel at the first valve disk does not flow along the valve seating surface of the second valve disk. The flow routes of the first and second valve disks are connected hydraulically in parallel.

According to an advantageous embodiment, the second valve disk is centered by a guide radially with respect to the valve seating surface. The discharge channel can extend between the guide and the second valve seating surface. This variant makes it possible to provide very large cross sections for the discharge channel while keeping the simplicity of the overall design.

Alternatively, the discharge channel can extend directly through the second valve disk.

With the goal of achieving the greatest possible variability with the use of basic, standardized components, at least one of the seating surfaces for the first valve disk is formed by a washer inside the damping valve device.

According to an advantageous embodiment, the second valve disk is formed by a rigid valve ring. The valve ring is then pretensioned by a separate spring onto the valve seating surface.

An especially space-saving solution is characterized in that the second valve disk is pretensioned by at least one disk spring, where the disk spring provides at least one outlet for the discharge channel of the first valve disk.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a cross-sectional view through a vibration damper;

FIG. 2 shows an exploded version of FIG. 1;

FIG. 3 shows a damping force characteristic for the inventive damping valve device;

FIGS. 4 and 5 show variants of FIG. 1;

FIG. 6 shows an exploded version of FIG. 4; and

FIG. 7 shows a damping valve device as a bottom valve.

### DETAILED DESCRIPTION OF THE PRESENTLY PREFERRED EMBODIMENTS

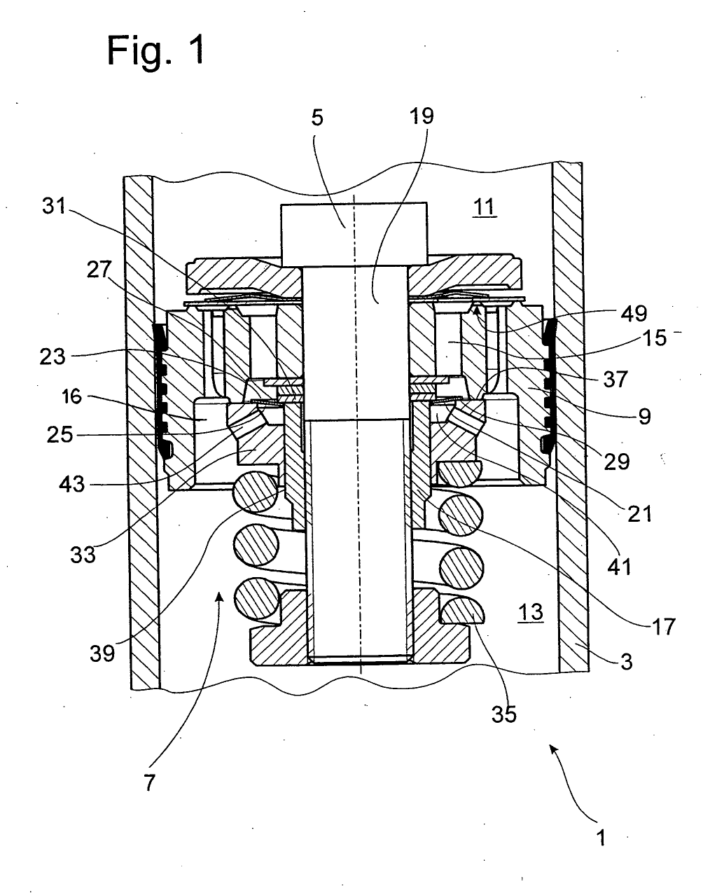

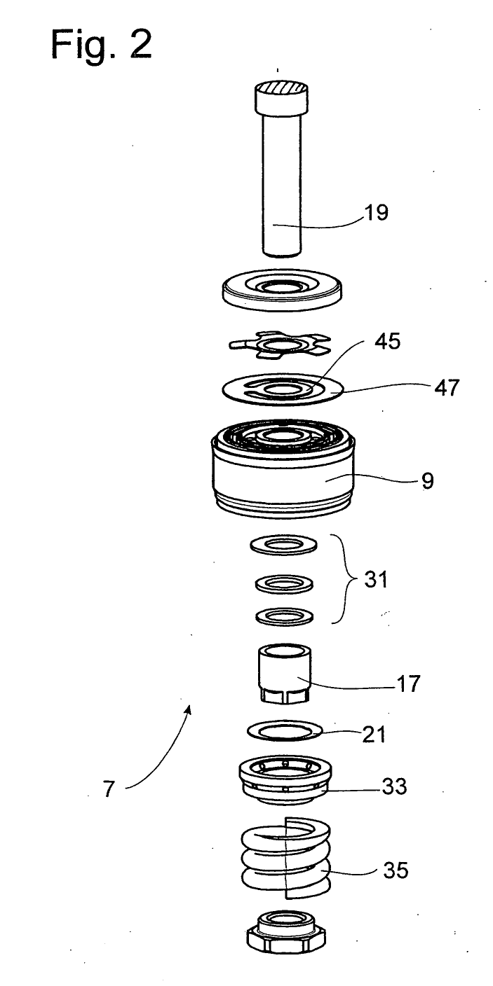

FIG. 1 shows part of a vibration damper 1, such as that used in a motor vehicle. A piston rod 5 with a damping valve device 7 in the form of a piston is installed with freedom of axial movement in a cylinder 3. An exploded view of the damping valve device 7 is shown in FIG. 2. A damping valve body 9 divides the cylinder 3 into a working space 11 on the piston rod-side of the piston and a working space 13 on the side of the piston opposite the piston rod. At least one flow channel 15 is provided inside the damping valve body 9; one end of this channel is connected without a throttling effect to the working space 11 on the piston rod side. A piston nut 17 holds the damping valve piston in place on a piston rod pin 19.

The end of the flow channel facing the working space 13 on the side of the piston opposite the piston rod is at least partially closed by a first spring-loaded valve disk 21. The spring-loading is produced by the tensioning of the valve disk 21 between a first valve seating surface 27, against which the one cover side 23 is braced, and a second valve seating surface 29, against which the other cover side 25 is braced. The first valve seating surface 27 is formed by at least one washer 31 inside the damping valve device. The outer edge of the first valve disk 21 is supported against the second valve seating surface 29, which is produced on a second valve disk 33. The second valve disk 33 is formed by a rigid valve ring and is pretensioned by a helical compression spring 35 against a valve seating surface 37 on the damping valve body. The rigid valve ring 33 is designed as an angle ring and is centered on a guide 39 of the piston nut 17. An annular space 41 extends between the lower cover side of the first valve disk 21 and the valve ring 33. This annular space 41 forms part of a discharge channel 43 for the first valve disk 21 to the working space 13 on the side of the piston opposite the piston rod. The annular space 41 extends between the guide 39 of the piston nut 17 and the second valve seating surface 29.

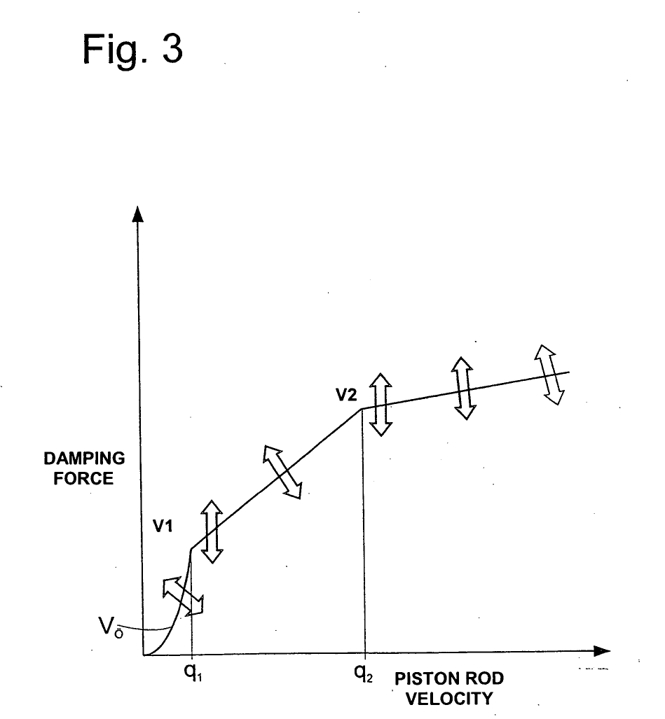

When the piston rod moves toward the working space 11 on the piston rod side of the piston, the following operating behavior is observed. The damping medium flows through a “c”-shaped opening 45 in a nonreturn valve disk 47 (FIG. 2) into the flow channel 15 of the damping valve body. In parallel, a small flow volume can escape through a pilot cross section 49, formed by a pressed-in area in a separating web, to a flow channel 16 working in the opposite direction and thus arrive in the working space 13 on the side of the piston opposite the piston rod. At slow piston rod velocities, the pilot cross section thus brings about a small damping force corresponding to section Vö of the characteristic curve (FIG. 3). If, because of a higher piston rod velocity, a higher pressure q₁ is built up in the flow channel 15, then the inside diameter of first valve disk 21 rises from the first valve seating surface 27 on the washer 31. The damping medium can now flow from the annular space 41 via the angled discharge channel 43 to the working space 13 on the side of the piston opposite the piston rod. The slope of the damping force curve decreases in comparison to the damping force curve Vö, which is determined by the pilot cross section. If the piston rod velocity increases even more, e.g., if a pressure q₂ develops, then the second valve disk 33 will also rise from its valve seating surface 37 against the force of the spring 35, where the second valve seating surface 29 and thus also the first valve disk 21 execute a lifting movement in synchrony with the second spring-loaded valve disk 33. The damping force curve again becomes flatter than it was in the preceding segment and ensures the safe and yet comfortable driving behavior of the vehicle. The arrows in FIG. 3 are intended to show possible ranges of variation of the damping force characteristics which can be achieved by changing the dimensions of the first and second valve disks and of the spring 35.

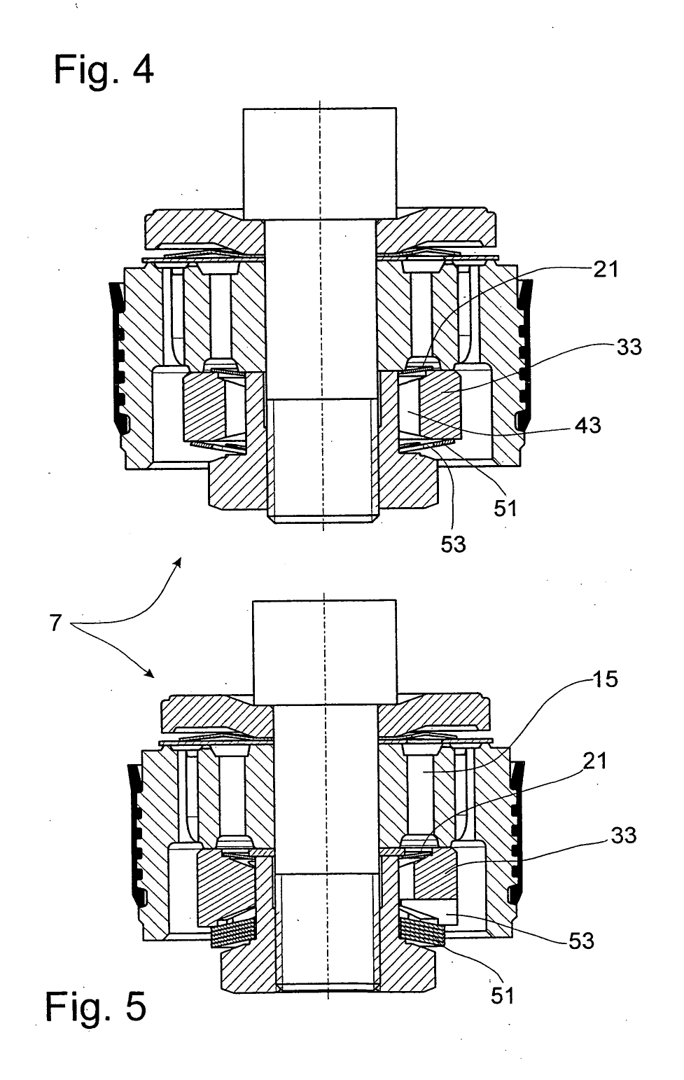

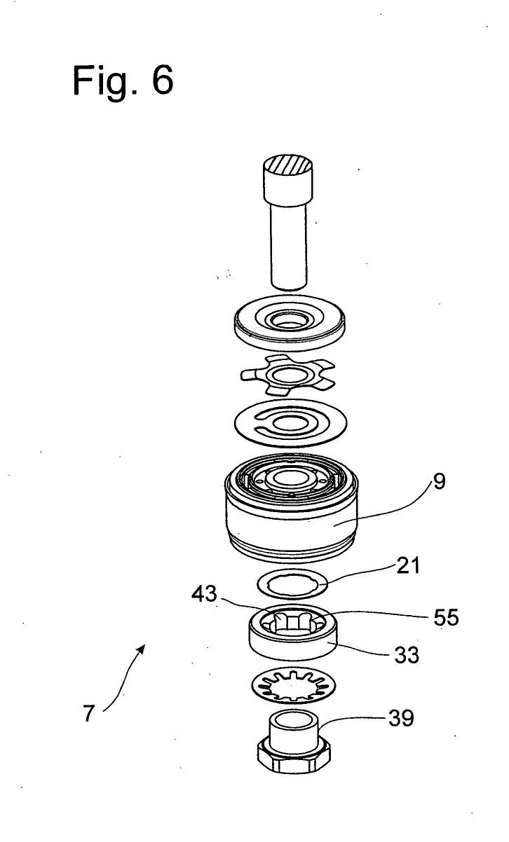

FIGS. 4 and 5 show a modification of the variant according to FIG. 1, in which the second valve disk 33 is pretensioned by a disk spring 51. In FIG. 4, a single disk spring 51 is used, which has an outlet 53 for the discharge channel 43 of the first valve disk 21. Alternatively, it is possible to use several disk springs 51 in a package. In this case it is simpler for the outlet 53 to lead out onto the second valve disk 33, e.g., onto its lower surface. The discharge channel 43, as can be seen upon consideration of FIG. 6 as well, is formed by radial webs 55 on the inside diameter of the second valve disk 33, which slide on the guide 39.

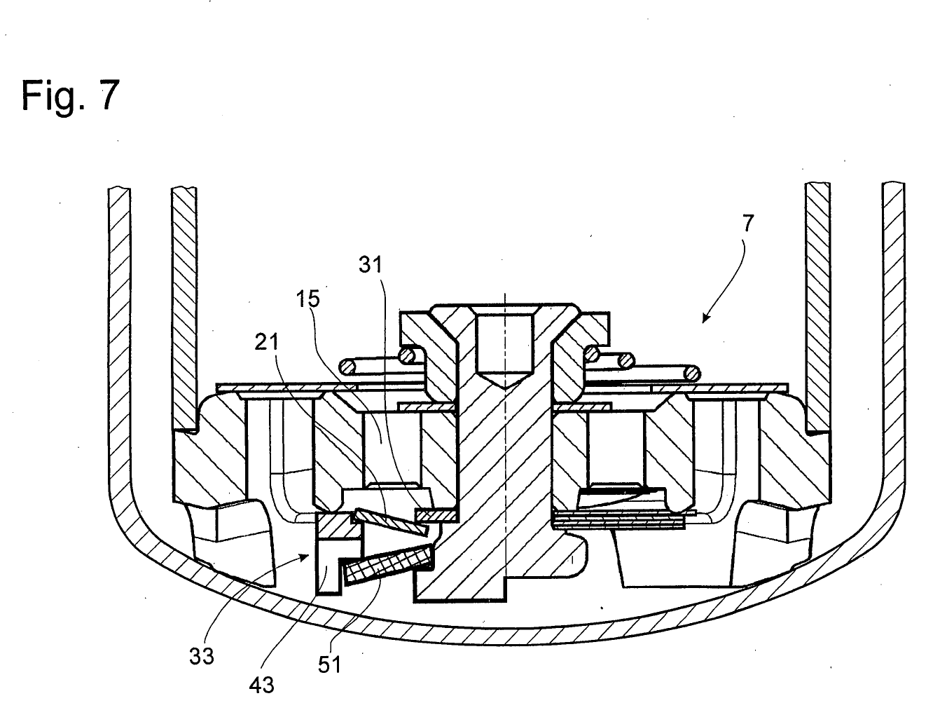

FIG. 7 shows the inventive damping valve device in the form of a bottom valve of a vibration damper 1. In this variant as well, the second valve disk 33 is designed as an angle ring and has a discharge channel 43 corresponding to the variant shown in FIG. 6.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A damping valve device comprising:
a damping valve body having at least one flow channel;
a first valve disk which at least partially closes said channel and has opposed cover sides which are spring loaded against respective first and second valve seats, said first valve disk rising from said first valve seat at a first opening pressure in said channel; and
a second valve disk which at least partially closes said channel and is spring loaded against a third valve seat, said second valve disk rising from said third valve seat at a second opening pressure in said channel, wherein said second opening pressure is higher than said first opening pressure;
wherein said second seat rises synchronously with said second spring loaded valve disk.

2. The damping valve device of claim 1 wherein the second valve seat is provided directly on said second valve disk.

3. The damping valve device of claim 1 wherein the second valve disk defines a discharge channel which receives damping medium when said first valve disk rises from said first seat.

4. The damping valve device of claim 3 further comprising a guide which centers the second valve disk radially with respect to the third seat, said discharge channel extending between the guide and the second valve seat.

5. The damping valve device of claim 4 wherein the discharge channel extends through said second valve disk.

6. The damping valve device of claim 1 wherein at least one of the first and second valve seats is formed by a washer.

7. The damping valve device of claim 1 wherein the second valve disk is formed by a rigid ring-shaped body.

8. The damping valve device of claim 1 further comprising at least one disk spring which loads said second valve disk against said third valve seat.

9. The damping valve device of claim 8 wherein the second valve disk defines a discharge channel which receives damping medium when said first valve disk rises from said first seat, said discharge channel having an outlet which bypasses said at least one disk spring.
